(19) United States
(12) Patent Application Publication
(10) Pub. No.: US 2007/0005395 A1
(43) Pub. Date: Jan. 4, 2007

(54) System and method for providing exercise programs, dietary foods and health information

(76) Inventor: Jaswir Singh, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/516,405

(22) Filed: Sep. 6, 2006

Related U.S. Application Data
(63) Continuation-in-part of application No. 11/060,054, filed on Feb. 16, 2005.

(51) Int. Cl. G06Q 10/00; A63B 71/00

(52) U.S. Cl. 705/2; 482/8

(57) ABSTRACT

A system and method for providing exercise programs, dietary foods and health and fitness information to persons desiring to improve their fitness and/or health. The system and method has a dietary and fitness/exercise plan that combines a dietary element, a fitness/exercise element and a written materials element. The dietary element provides one or more calorie-controlled foods to the user. The fitness/exercise element provides videos with one or more fitness/exercise routines for the user to follow. The written materials element provides charts, tables and graphs for the user. In the preferred embodiment, the user also has access to an online gym through the Internet or other transmission system. The online gym includes a database having a plurality of exercise video programs providing different types of fitness and exercise classes that can be accessed by registered users at a date, time and place that is convenient for the user to exercise.

### CROSS-REFERENCE TO RELATED APPLICATIONS

This patent application is a continuation-in-part of U.S. patent application Ser. No. 11/060,054 filed Feb. 16, 2005.

### BACKGROUND OF THE INVENTION

A. Field of the Invention

The field of the present invention relates generally to systems and methods of providing information, goods and services to individuals desiring to improve their health and fitness. More particularly, this invention relates generally to such systems and methods that are directed to providing exercise and fitness programs, dietary and meal replacement products and exercise, fitness and dietary information to consumers. Even more particularly, the present invention relates to such systems and methods that also include providing interactive exercise video programs and exercise related goods to subscribers via the Internet or other transmission system.

B. Background

In today's society, most people know that watching their diet and following a fitness program can result in improved health, increased longevity, a more enjoyable life and other substantial benefits. As is also well known, many of these benefits are only achievable by engaging in sustained exercise, meaning exercise of sufficient intensity and durability to provide the desired benefits, on a regular basis. Despite the well known benefits of proper diet and exercise, information is widely available which indicates that a vast majority of people, particularly Americans, do not eat properly and do not get a sufficient amount of sustained exercise. As a result, many people are not considered to be physically fit or to be in good physical health. In fact, despite the many years and substantial effort by numerous government and private organizations to promote good health and exercise, many people are considered to be overweight or even obese. The health problems that are associated with the lack of exercise spans across all racial, gender and age boundaries. With regard to young people specifically, the lack of exercise and the problems resulting therefrom have been widely reported in government and private studies discussed by the media. Although many of the health problems associated with the lack of exercise may not become substantial or life threatening until a person is older, the importance of exercise for younger persons is well known. With regard to persons of any age, the lack of exercise hinders the person's ability to enjoy an active lifestyle. This is particularly true as people are living longer and having more years of life after retirement. With the additional time available to older persons after retirement, many of these people wish to engage in activities that are only doable or enjoyable, such as tennis, golf, hiking, long walking tours, swimming and the like, by being in good physical condition. Regular exercise is known to provide persons the ability to engage in numerous physical activities and have more fun while doing the activity.

In addition to improving the desire and ability to engage in physical activities, following recommended fitness and exercise guidelines, which have been established by various government agencies and private organizations, is also known to generally improve a person's health. The cost and availability of health care is a major issue in the United States. This is particularly true as the population of our country is generally becoming older. Although regular, sustained exercise is known to improve a person's health and reduce his or her likelihood of a number of health issues, including heart related diseases, most people have a difficult time obtaining sufficient exercise. As a result, in part, preventable health care costs have dramatically increased over the years. In response thereto, health care insurance premiums have substantially increased. For many individuals and companies, particularly small companies, health care and health insurance costs are a substantial financial burden. Naturally, for those persons who cannot afford or otherwise do not have health insurance, staying healthy is a financial necessity that must not be ignored.

Do in large part to the increased awareness of the health benefits of exercise and the desire for persons to be more physically fit, a number of health clubs and other exercise facilities have opened over the years to provide exercise equipment and classes to their patrons. Although many of these health club and health club related facilities are owned or operated by large companies, the market for such facilities is somewhat fragmented, with no one company controlling much of the market. Even in moderately sized cities, there are generally a multiple number of health clubs operated by a number of different owners. The cost and complexity of owning and operating health club facilities, from the initial investment in the buildings and exercise equipment to the ongoing costs of personnel, utilities and equipment upkeep or replacement, is known to be somewhat substantial. In order to keep existing customers and attract new customers, exercise and health clubs have found it desirable or necessary to offer more than just a place to use exercise equipment. Today, in addition to or even alternatively to weights and weight machines, most exercise and health clubs provide a variety of exercise classes and programs that are designed to appeal to persons interested in more than just the traditional methods of exercise. Although these classes were originally limited to standard aerobics exercises, most exercise classes today are directed to specialty types of exercise that may or may not involve the use of exercise equipment. For instance, classes are offered in such diverse activities as kick boxing, step aerobics, spinning using exercise bikes, yoga, pilates and a variety of others.

Although the various fitness classes and programs are very popular at most health clubs, they are known to have a number of limitations that prevent many people from fully benefitting from such classes and programs. One known limitation is that a person generally must join the health club in order to be able to participate in the exercise classes or programs. Even if the person is not at all interested in certain of the club's benefits, such as the exercise equipment, swimming pool, racquet courts and the like, his or her membership fees still reflect the initial investment, employee and upkeep costs associated with these benefits. Another known limitation is that the person can only participate in the class or program by being there at the date and time it is offered, whether that is a convenient date and time or not. For instance, a person who is a member at a particular health club may be interested in attending a certain class but, due to work or other conflicts, the schedule for the class is such that the person cannot participate. Even if the person's schedule is such that the class is generally available for them to attend, there is likely to be occasions when attending a particularly scheduled day or time will not be possible due to last minute conflicts. Another limitation is that the person must get to the health club, which under normal conditions typically requires driving to and from the health club and under bad weather conditions requires doing so in the fog, rain or snow. Yet another drawback, at least for some people, is the fact that the exercise classes are typically held as a group session and often in view of the other patrons of the health club. Although some people enjoy exercising in front of others, this is not the case for many, if not most, people who need to exercise. Whether because of embarrassment due to being so out of shape or due to general modesty and privacy concerns, some people are very reluctant to get into exercise clothes and exercise with a group of people, particularly if they feel the setting is such that they are on display (i.e., open areas or windows) while exercising.

The desire of persons to get into shape by exercising, particularly as part of a class-type of setting as opposed to running or the like, has resulted in a significant industry related to exercise video programs, whether offered on video tapes, DVDs or other formats. In fact, the amount of money spent on exercise video programs is substantial. Despite the popularity of such exercise video programs, particularly those having celebrity instructors, these programs are also known to have a number of limitations that prevent their full acceptance by many consumers. One of the major drawbacks to such exercise video programs is the cost associated with the purchase of a single program. The costs of the video tape, DVD or like is generally not insignificant, particularly when the consumer is not really sure if he or she will even like the program, the instructor or both. Often it may be hit or miss whether a particular consumer is going to enjoy interacting with a particular exercise program or the instructor leading/teaching the program. Even if the consumer does like the particular exercise program and instructor, there is a significant tendency for the consumer to become bored watching the same exercise video program over and over again. For those who master the exercise routine, this can be a particular problem that leads them to abandon the program and either cease exercising or have to purchase another exercise video program. Although some suppliers address this problem by providing graduated exercise or skill levels, taking advantage of these extra levels generally requires the consumer to purchase additional video programs from the supplier, resulting in an ever increasing investment in such programs.

As stated above, it is well known that good health generally requires the combination of exercise and a proper, well-balanced diet. Many of the same problems that prevent most people from getting enough exercise also prevent people from eating the proper foods at the proper levels and time of day. It is well known that the demands of modern life, particularly for Americans, result in many people eating meals that are not nutritious, selecting instead food or meals that are easy to prepare or which are prepared for them (i.e., fast foods), many of which are not selected for their healthful content. In addition, many people tend to skip a meal altogether and then, due to hunger, end of eating too much later in the day. Often, the later in the day may be late in the evening or even at night, when the body will not be able to properly process the food before sleep. Studies have indicated that eating unhealthy foods, skipping meals and eating late in the day are all factors that result in unwanted weight gain and, in general, less than desirable health. Combined with the lack of exercise, it is no surprise that many Americans are overweight, have weight-related health problems and are generally not in good shape.

Many people attempt to solve the problems of not having a proper diet on their own by purchasing healthier snack foods to curb hunger and calorie controlled meal replacement packages, including certain drink mixes and frozen foods, for the primary meals. While this may generally provide the person with a somewhat better diet, typically it is not sufficient to obtain the health and fitness results intended due to the inability of the average person to select the proper combination of foods to avoid hunger yet control calorie consumption. As a result of the desire for a better diet and to lose weight, a number of companies offer dietary programs that provide the consumer with dietary foods and information on how to lose weight. Many of these programs include specific, calorie-controlled snack foods and meal replacement foods with a schedule (i.e., time of day and day of week) when to eat which items. While these programs generally provide consumers with healthier meals and better control over their diets, none of these programs provide consumers with the combination of a diet and fitness program that makes it easier and more effective for the consumer to control his or her diet while obtaining the fitness necessary for good health.

What is needed, therefore, is an improved system and method of providing a combination diet and fitness program that makes it easier for the consumer to control his or her calorie intake while engaging in an exercise program selected to improve their fitness. The preferred system and method should include fitness videos and written materials, such as brochures and the like, that assist the consumer with his or her diet and fitness program. Preferably, the system and method integrates a snack and meal replacement program with fitness videos, such as in DVD format, in a manner that is directed to provide overall improved health for the consumer. The preferred system and method should have exercise and fitness video programs available to consumers who wish to participate in such programs via the Internet, cable/satellite television or other transmission systems. Preferably, the system and method should allow a consumer to choose to participate in an exercise class or program at a day and time that is convenient to him or her by providing such classes and programs through an on-demand type of arrangement. The preferred system and method should also eliminate the cost associated with having to join an exercise or health club in order to be able to participate in an exercise class or program. The preferred system and method should also allow the consumer to choose the location that he or she will interact with exercise program to avoid having to go to a facility and/or exercise in a group setting. The preferred system and method should provide various levels of memberships and allow the consumer to choose from a variety of different classes at different intensity and/or skill levels.

### SUMMARY OF THE INVENTION

The system and method for providing exercise programs, dietary foods and health information of the present invention provides the benefits and solves the problems identified above. That is to say, the present invention discloses a system and method that comprises a fitness/exercise plan having a dietary element, a fitness/exercise element and a written materials element that integrates diet and fitness/exercise programs in a manner that substantially improves the way in which people can improve their fitness and obtain better health. The present invention combines various dietary snack and meal replacement plans with fitness and exercise videos, preferably in the form of DVDs and the like, in a manner that simplifies the process of controlling one's weight and fitness levels. The system and method of the present invention provides the consumer with dietary and fitness information that he or she can utilize with a dietary and fitness program to lose or maintain their weight and improve their fitness to obtain better overall health.

In addition to the combination dietary and fitness program, the system and method of the present invention includes an online gym that permits the user to better interact with exercise classes or programs by allowing a person to choose the day, time and location to engage in a fitness or exercise program. The present invention combines the dietary/fitness program with an online gym business method that provides a database comprising a collection of numerous exercise video programs having different types of exercise classes, such as kick boxing, pilates, yoga, step aerobics and the like, taught by instructors in a class-type of setting that can be accessed by registered users at a day and time that is most convenient for them to exercise. The database can be configured to include different exercise routines for the same type of exercise class and have different levels of exercise intensity to allow the user to progress to higher levels as he or she is able. Preferably, the database is accessible via the Internet so the user can have access at the home, office, hotel rooms and many other Internet configured places. Alternatively, the database can be configured to be accessible through a cable or satellite television system or a combination Internet/television system. The system and method of the present invention eliminates the need to join a health or exercise club for the person who merely wants to participate in exercise classes and allows persons to exercise in the comfort of their own home, office, room or other location. As such, the present invention is particularly friendly to and useable by those persons who do not desire to exercise in public and to those persons who, due to weather, car problems or other concerns, do not or cannot get to the health club. The preferred method is configured to allow different levels of memberships to allow registered users to access different features of the exercise video program database.

A preferred embodiment of the online gym of the present invention for providing exercise programs, goods and services over a transmission system, such as the Internet, generally comprises the steps of providing a user interface that is connected to and accessible through the transmission system, providing a database that is operatively connected to the user interface, allowing the user to selectively choose one of the video programs from the plurality of exercise video programs as his or her selected video, and delivering the selected video to the user via the transmission system. The database of the preferred embodiment of the present invention comprises a plurality of exercise video programs that are accessible to users, particularly registered users, through the user interface via the transmission system. In the preferred embodiment, the user accesses the database through a video device, such as a personal computer, digital video recorder or digital television, having a transmission system interface configured to access the transmission system and play the selected video on the video device so the user can exercise while watching the selected video. The user interface can be configured to determine if the user is a registered user, to register new users and to allow trial reviews for potential registered users. In the preferred embodiment, the database has a plurality of plan levels and the user is prompted to select one of the plurality of plan levels as his or her user plan when he or she becomes a registered user or to upgrade while a registered user. Each of the various plan levels include a selected subset or group of the complete database of exercise video programs. The user interface is configured to allow the user to access his or her user plan and choose a video from the group of exercise video programs in his or her user plan. Preferably, the database also includes a plurality of pay-per-view video programs, a marketplace section and a health fitness section. The user interface should be configured to allow the user to select one of the plurality of pay-per-view video programs as the selected video. The marketplace section should be configured to allow the user to purchase one or more goods and services through the transmission system.

In the preferred embodiment of the online gym system of the present invention generally comprises a server computer having a user interface connected to and accessible through the transmission system (preferably the Internet), a database stored on the server computer and operatively connected to the user interface, a video device connected to the user interface through the transmission system, and a transmission system interface that connects the video device to the transmission system. As set forth above, the database has a plurality of exercise video programs that are accessible to the user via the transmission system and the video device is operated by the user so as to allow the user to selectively choose a selected video from the plurality of exercise video programs. The transmission system interface is configured to receive the selected video from the database via the transmission system and play the selected video on the video device to allow the user to interactively exercise while watching the selected video. For use with the Internet, the transmission system interface should comprise an appropriately configured Internet browser. The database used with the system has a plurality of plan levels each that each have a group of exercise video programs. The user interface is configured to allow the user to access his or her user plan and choose a video from the group of the exercise video programs in that plan. The database should include a plurality of pay-per-view video programs, a marketplace system and a health/fitness section. The user interface is configured to allow the user to select one of the plurality of pay-per-view video programs as the selected video and play that video on his or her video device.

Accordingly, the primary objective of the present invention is to provide an improved system and method for providing exercise programs, dietary foods and health information to consumers that provides the advantages described herein and that overcomes the disadvantages associated with presently available systems and methods of providing such exercise programs, dietary foods and health information, particularly non-integrated gym-based methods, video/DVD tapes and dietary programs.

It is also an important objective of the present invention to provide a system and method for providing an integrated dietary and fitness program to a consumer that includes dietary snacks and meal replacement plans with exercise and/or fitness DVDs and written materials explaining the incorporation of the diet and fitness/exercise plans.

It is also an important objective of the present invention to provide a system and method for providing exercise programs which comprises a database having plurality of exercise video programs that are accessible to users through an online, Internet-based server or by other transmission systems to allow the user to play a selected exercise video program so that he or she may interact therewith for exercise.

It is also an important objective of the present invention to provide a system and method for providing exercise programs through an Internet or other transmission system to a registered user that provides access to different types and levels of exercise video programs depending on the access plan selected by the user.

It is also an important objective of the present invention to provide a system and method for providing exercise programs that provides different levels of access to a database of exercise video programs, including unlimited, on-demand access to a plurality of exercise video programs within a group of programs for which the user is registered and options to allow the user to select other exercise video programs on a pay-to-watch type of arrangement.

It is also an important objective of the present invention to provide a system and method for providing exercise programs that allows the user to select when and where he or she desires to exercise in conjunction with an exercise class or program, thereby eliminating the user's dependency on health clubs and gyms for attending such classes or programs.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a flow diagram illustrating the steps for providing an integrated dietary and fitness/exercise program to a user of the system and method of the present invention;

FIG. 2 shows the general arrangement of a system configured to access and utilize the present invention, including a server configured to store a plurality of exercise videos and other information, the Internet and display devices and systems configured to receive and play a video selected from the server;

FIG. 3 is a logic flow diagram showing user access to a database system for playing exercise video programs in accordance with an embodiment of the present invention; and

FIG. 4 is a logic flow diagram illustrating the steps for handling a new user in accordance with an embodiment of the present invention.

### DETAILED DESCRIPTION OF THE PREFERRED EMBODIMENTS

With reference to the figures where like elements have been given like numerical designations to facilitate the reader's understanding of the present invention, and particularly with reference to the embodiments of the system and method for providing exercise programs, dietary foods and health information of the present invention illustrated in the figures, a preferred embodiment of the present invention is set forth below. The enclosed description and drawings are merely illustrative of one or more preferred embodiments and represent several different ways of configuring the present invention. Although specific components, materials, configurations and/or uses of the present invention are illustrated and set forth in the drawings and disclosure, those skilled in the art will readily understand that these embodiments are exemplifications of the principles of the present invention and that a number of variations can be made thereto without changing the scope and function of the invention set forth herein.

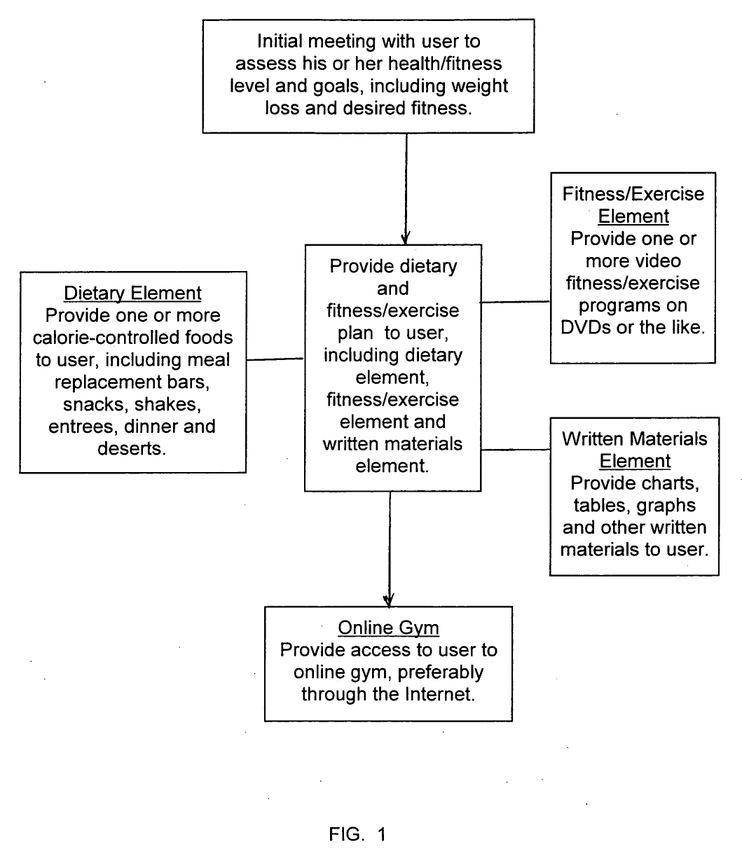

In reference to FIG. 1, a preferred embodiment of the system and method for providing fitness/exercise programs, dietary foods and health information to a user is identified generally as 2. The objective of the system and method 2 of the present invention is to provide a complete, integrated food and fitness program that makes it easier for the user to maintain good health or lose weight and/or improve their fitness levels to reach a condition of good health. As shown in FIG. 1, the process begins at box 4 with an initial meeting between a dietary/fitness consultant and the user to assess the user's present health, which may include gathering vital statistics such as height, weight, body type and blood pressure, and his or her overall fitness. Depending on the sophistication of the system and the cost to the consumer, various blood and fitness tests (such as an EKG or the like) can be performed to assist the consultant with understanding the user's current health and fitness level. The user's health and fitness goals are also assessed at the initial meeting. These goals may include specific objectives, such as losing fifteen pounds, fitting into certain clothes or being able to run a marathon, or they may be more general in nature, such as being able to have a more active and longer life through improved diet and fitness. As well known in the art, not all people have the same health objectives or fitness goals. People in very good health and at higher than normal fitness levels may have very specific goals that they wish to have assistance with, such as being able to improve on their current abilities (i.e., running, bicycling, swimming, etc.) or even just desire to have assistance with maintaining their current fitness levels. Most people, no matter what their health or fitness level, are not very knowledgeable about the specifics of diet and fitness and do not have the time or inclination to become an expert in this area. As such, their ability to have control over their own dietary intake and fitness levels is substantially limited.

The initial meeting 4 to assess the user's current health and fitness levels and their goals of the present invention is somewhat similar in concept to what is done, separately, at the various dietary and fitness organizations currently available, with the very important distinction that the present invention combines these two considerations into one integrated health program 2. Likewise, the step of providing an integrated dietary and fitness/exercise plan, shown as 6 in FIG. 1, has not heretofore been combined as set forth in the present invention. While there are organizations that provide dietary plans, food and guidance and other organizations that provide fitness and exercise plans, including fitness trainers and the like, prior to the present invention there has not been an integrated approach to providing dietary and fitness/exercise program to a user. Although it is widely recognized that good health is a combination of diet and exercise, prior to the present invention these have not been provided to the consumer in a way that facilitates him or her actually achieving their health and fitness objectives. This failure to provide an integrated diet and fitness program likely accounts for the reason why so many people are unable to lose weight, although they may spend significant sums of money and time on diet programs, and reach their health goals. The system and method 10 of the present invention integrates the two most important aspects of good health, diet and exercise, into a manner that makes it easier and, therefore, more likely to achieve.

In the step of providing dietary and fitness/exercise plan 6, the user is provided with a dietary element, shown as 7 in FIG. 1, that includes various calorie-controlled foods, such as meal replacements and snacks, that are chosen based on the user's current levels and objectives. The dietary element 7 is likely to include meal replacement bars, snacks and/or shakes (or other drink mixes), entrees, dinners and deserts. Like many of the present available dietary programs, the dietary element 7 of the present invention will include specific food groups and types that are necessary for good health in quantities that are sufficient to prevent hunger, yet not provide too many, generally unnecessary, calories. Typically, this type of dietary program includes smaller, nutrition and calorie-controlled main meals with calorie-controlled snacks therebetween to avoid hunger between meals, which is known to result in the person overeating or binging on unhealthy foods between meals. Dietary element 7 will provide the user with a diet program that is based on the individual (i.e., the program will be different for a 200 lb man versus a 120 lb woman) and on the person's current and planned fitness programs and objectives (i.e., a person just wanting to be fit will have a different program than someone planning a marathon).

In addition to providing the dietary element 7, the system and method 2 of the present invention also includes a fitness/exercise element, shown as 8 in FIG. 1, that is designed to assist the user with achieving his or her health objectives. In the preferred embodiment, the user is provided with videos in the form of DVDs that set forth various fitness and exercise routines that will direct the user toward his or her desired fitness goal. These routines will include, depending on the user and his or her current fitness level and goals, various exercises, including stretches, calisthenics and weight training, and specific forms of fitness training, such as running, kickboxing and the like. Alternatively, instead of DVDs, the user can be provided with this information in the form of video tapes, audio tapes, CDs or other types of media that have the desired fitness and exercise programs thereon. As known to those skilled in the art, the fitness/exercise element 8 of the present invention can be provided at specific levels that are geared to the user's current fitness levels to assist him or her with achieving their goals in a reasonable, stepwise fashion to avoid injury and burnout. For instance, the person who desires to run a marathon can be provided with a fitness/exercise plan that, over time, develops his or her ability to run long distances.

In addition to the dietary element 7 and fitness/exercise element 8, the system and method of the present invention includes a written materials element, shown as 9 in FIG. 1, that assists the user with the integration of the dietary element 7 and fitness/exercise element 8. In the preferred embodiment, the written materials element 9 will include brochures, pamphlets and similar written materials that provide the user with advice on how to apply the dietary element 7 and fitness/exercise element 8, separately and in combination, and to assist the user with tracking his or her health and fitness progress. For instance, the written materials element 9 can include suggestions for time of day and day of week consumption of foods that, taken together with the user's fitness/exercise program, is directed to maximizing efficient calorie intake and burning. The written materials element 9 can also include information on foods that are beneficial to consume and those which should be avoided, particularly those that are counterproductive with regard to the user's fitness goals. The written materials element 9 can also include information on how to perform the planned fitness/exercise program (i.e., the various steps involved in the stretches and/or exercises) and information to assist the user with merging his or her planned fitness/program into their daily schedule. In addition, the written materials element 9 can include charts, tables and graphs that the user can utilize to track his or her progress with regard to the diet and fitness/exercise programs. For instance, the user can be provided with a chart to track his or her weight loss, measurements, mileage and other statistics that may be useful or beneficial to the user. If desired, the user can also be provided with charts, tables and graphs that are useful for accomplishing their fitness/exercise objectives, such as heart rate charts, weight lifting charts, muscular development drawings and the like. In addition, written materials element 9 can include charts, tables and/or graphs for the user to track his or her blood pressure, blood/sugar levels and/or other “medical” type of information that may be applicable to the user.

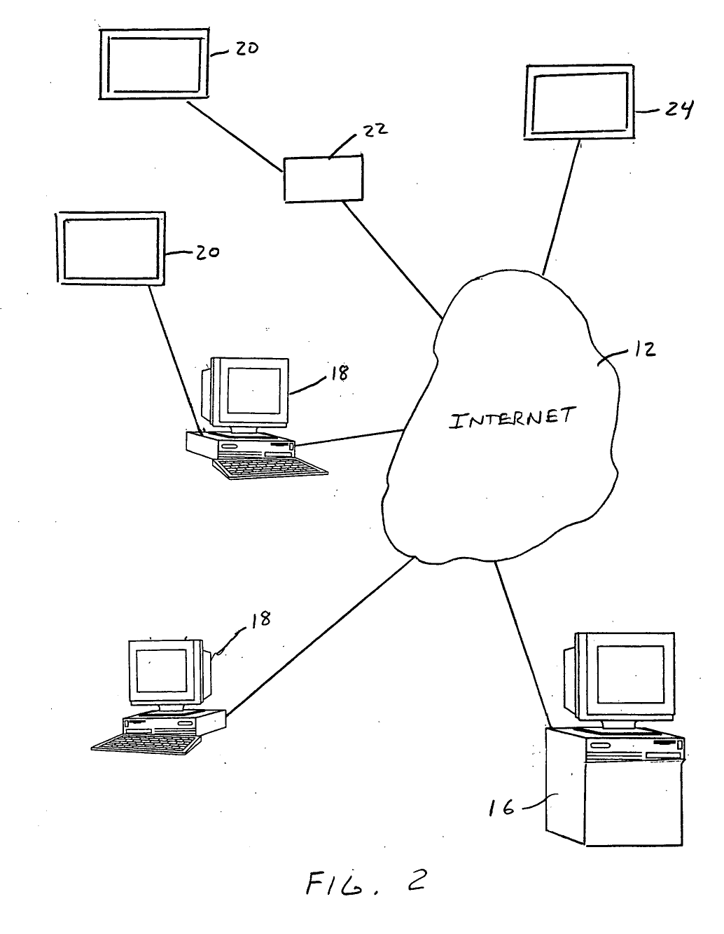

As shown in FIGS. 1 through 3, a preferred embodiment of the system and method of providing exercise programs, dietary foods and health information 2 of the present invention also includes access to an online gym, identified generally as 10. Preferably, the online gym 10 is configured for use with the Internet 12 so the user can readily access the database 14 having a plurality of previously recorded exercise video programs such, as those described below, from a variety of different locations. As is well known, many people have access to the Internet at their homes and offices. In addition, many hotels and motels offer Internet access in their rooms, often for a nominal fee. By providing access to the database 14 of the present invention 10 via the Internet 12, users will be able to benefit therefrom in the privacy of their homes, offices or hotel and motel rooms virtually anywhere in the world. As is well known with regard to Internet-based database systems in general, the system of the present invention 10 comprises a central server computer 16, or computer system comprising a plurality of such server computers 16, that have adequate memory and processing power to be suitable for storing the database 14 thereon and allowing access thereto from the Internet 12. Access to database 14 by the users can be by a variety of video devices, such as personal computer 18 shown in FIG. 1, that are also connected to the Internet 12. As illustrated in FIG. 2, depending on the user's set-up and equipment capabilities, computer 18 may interconnect a television 20 to the Internet 12, a digital recording device 22 (such as a TiVo® or similar device) may interconnect television 20 to the Internet 12 or a digital television 24 may be configured to connect directly to the Internet 12. As well known, connection to the Internet 12 may be achieved through cable modems, DSL systems, satellite, T-1 cable systems, wireless and dial up modems having 28k, 56k or higher connectivity capability.

For purposes of the disclosure herein, the online gym 10 is generally described in conjunction with an Internet-based transmission system. However, as those skilled in the art will recognize, the invention is not so limited. The online gym 10 can be configured to be utilized with a variety of different video/data transmission systems which are capable of allowing the user to interact therewith. For instance, the online gym 10 may be configured to be used with a cable television system, satellite systems or other present or future transmission systems that allow the user to interact therewith to select an exercise program, as explained in more detail below, for viewing on his or her video display device. User interactivity is presently well known in the art of providing video materials, as illustrated by the various pay-per-view types of services. It is contemplated that in the future there may be transmission systems which are an improvement over the presently available transmission systems, including the Internet 12. In any such transmission system, the goal is to allow the user to interact with database 14 configured according to the principles of the online gym 10 so that he or she may exercise therewith (as explained in more detail below).

As is well known in the art, the video device, such as a personal computer 18, television 20, digital recorder 22 or digital television 24 shown in FIG. 2, must be configured to be able to display digital video images. For instance, in addition to sufficient connectivity capability, computer 18 must be configured with sufficient memory and processor speed to adequately process the digital video images associated with the exercise video programs of the online gym 10. In addition, the video device must have a transmission system interface having the capability to connect to the transmission system and a video display system, including a monitor and a high speed video card, capable of providing the desired video output quality. To connect to and interact with the Internet, personal computer 18, or other video devices, must be configured with an appropriate Internet browser, such as Microsoft's Explorer® program. In addition, personal computer 18 will have to be provided with video display program, such as Real Player®, Windows Media Player® or Apple QuckTime®, suitable for playing the exercise video program. In general, the aforementioned programs, as well as others, are available for downloading from the Internet, or elsewhere, for a small or no fee (included with the computer, etc.). Once properly configured, the appropriate video device will be capable of receiving and playing an exercise video program selected by the user in accordance with the online gym 10 of the present invention.

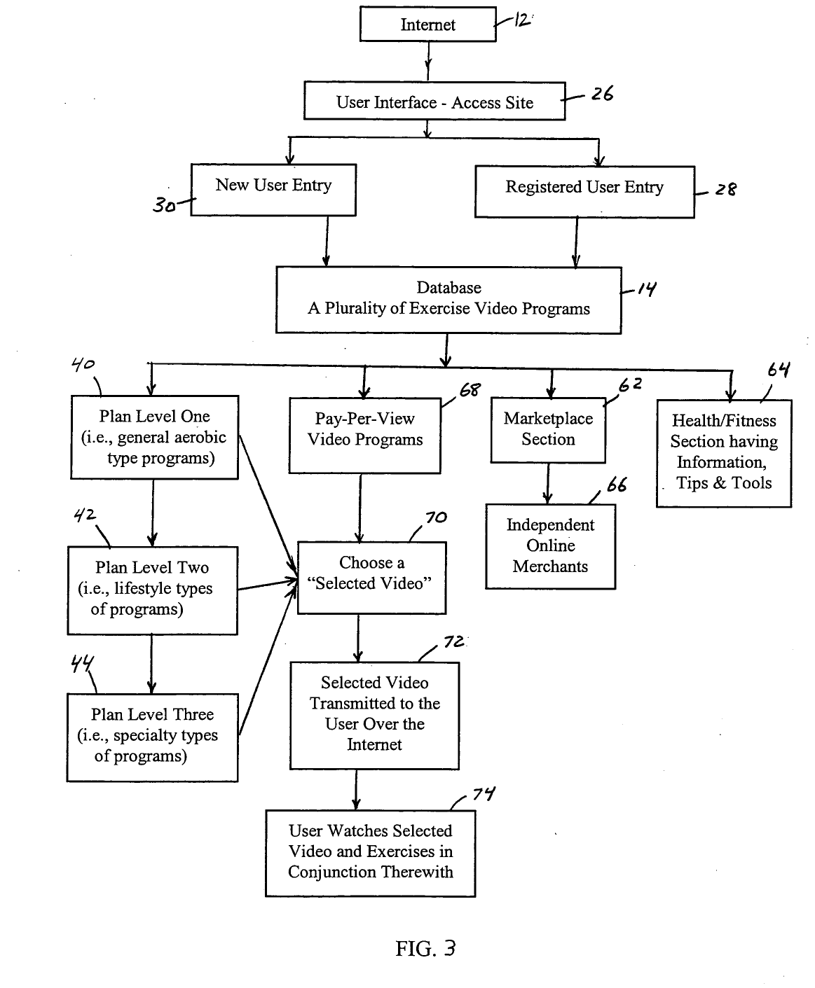

A flow diagram illustrating the steps of a preferred embodiment of the online gym 10 of the present invention showing the interaction between the user and the database 14 is shown in FIG. 3. Initially, the system/method 10 is provided with a user interface 26 which is accessed via the Internet 12. As known to those skilled in the art, user interface 26 can welcome the user to the system/method 10 of the present invention, provide information regarding the services offered and request information from the user to proceed to access database 14, where a plurality of exercise video programs are stored. The first phase of the online gym 10 is to determine whether the user is a registered user or a new user. If the user is a previously registered user, then he or she will be directed to enter his or her user name and password, as shown at 28 on FIG. 3. Once the user name and password are entered and accepted, the user will be allowed access to database 14. If the user is not a registered user, he or she can be directed to become a new user, as shown at 30. As known in the art, the new user can be allowed access to database 14 in several different ways. For instance, new user could become a regular registered user whereby he or she pays a monthly or annual fee via credit card, bank withdrawal or mail-in payments. Alternative, new user could be provided with short-term access (i.e. a week or month, as may be appropriate or desired) to the online gym 10 of the present invention so that he or she could try it out before committing to a longer term contract. In another alternative, new user could be provided with a short term free access (i.e., three day pass) to database 14 to encourage him or her to become a registered user.

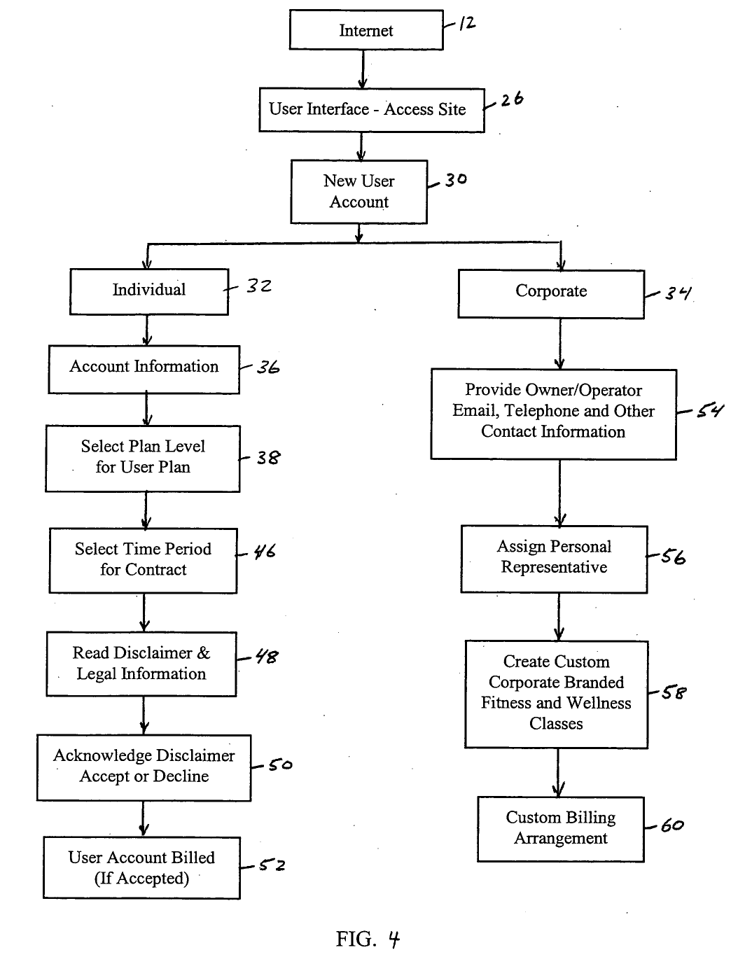

A flow diagram illustrating the steps of a preferred embodiment of the online gym 10 of the present invention for handling a new user is shown in FIG. 4. After accessing the site at user interface 26 through the Internet 12 and being directed to the new user account profile 30, the new user either selects the individual 32 or corporate 34 account status to enter the required information. If the new user is an individual, he or she will be directed to select a user name and password and then to enter the required account information, including name, address, telephone, email and payment information. After entering the necessary information, the new user is directed at 38 of FIG. 4 to select a plan level, such as Plan Level One 40, Plan Level Two 42 or Plan Level Three 44 (naturally, these plans may be referred to by other names, such as bronze, silver and gold) shown on FIG. 3. After selecting a plan, hereinafter referred to as the user plan, the new user is directed to 46 of FIG. 4 to select a time period, such as a trial period, one month, one year or multiple year periods for his or her commitment. As is known in the art, generally the new user can be provided with a discount for selecting longer periods of time. After selecting a time period the new user is directed to read the disclaimer and other legal information, shown at 48, that is required or recommended with regard to injuries, cancellations and other site specific information. The new user is then directed, at 50, to enter information whereby he or she acknowledges reading the disclaimer and legal information and then enters his or her desire to accept or decline the service. If the new user accepts the service, then the new user's account (such as a credit card or bank) is accessed at 52 and he or she becomes a registered user.

If the new user selects the corporate account status at 34, the user is provided information on opening a corporate or corporate-type account having multiple users who can access database 14 for the purposes described herein. At 54, the new user is given the email address, telephone number and other contact information to contact the owner of online gym 10 to facilitate the set-up of a corporate account. Alternatively, the corporate new user is prompted to provide his or her contact information so a representative of the owner can contact the corporate representative. In either instance, at 56 the owner of online gym 10 assigns a personal representative to the corporate account. At 58, the personal representative assists the corporate representative in creating custom corporate branded fitness and wellness classes that may be specifically targeted for the employees and other members of the corporate account. A custom billing arrangement for the corporate account is provided at 60. Once the corporate account is created, as well as any necessary sub-accounts, the employees and other members of that account can access the database 14 of the online gym 10 as registered users.

In reference to FIG. 3, after a user accesses database 14 of the online gym 10 of the present invention, he or she is directed either to select a exercise video program that he or she desires to interact with (as explained in more detail below) or to marketplace section 62 or health/fitness section 64 of the online gym 10. If the user chooses the marketplace section 62, he or she can be directed to purchase materials provided by the operators of the online gym 10 or, as shown at 66, to independent online merchants offering health and/or fitness related goods, such as clothing, sport drinks, nutrition bars, exercise equipment and the like, or a variety of health and/or fitness related services, such as sports medical services, diet programs, private training sessions and the like. The operators of online gym 10 can have financial arrangements with the independent online merchants such that the operators thereof receive a percentage of all goods or services purchased by a registered user as a result of the referral by the online gym 10. At health/fitness section 64, the user can obtain information related to maintaining a healthy lifestyle, such as dietary, sleep and related data, or information related to improving his or her fitness, such as tips and tools on how to achieve the desired results faster, how to maintain the results achieved, methods of stretching, use of equipment and materials and the similar data. If desired, the operators of online gym 10 can allow non-registered users (i.e., guests) to have complete or partial access to the health/fitness section 64, bypassing the requirements of user interface 26, as a way to market the online gym 10 and/or as a public service.

In further reference to FIG. 3, once a user, typically a registered user, enters the database 14, he or she can either choose to select one of the many available exercise video programs available under his or her user plan or select an exercise video program from the “pay-per-view” section, shown at 68, of the database 14. Once a exercise video program is selected, referred to as the “selected video” at 70, the selected video is electronically transmitted, shown at 72, to the user via the Internet 12 or other transmission system being utilized with the online gym 10 of the present invention. At 74, the user can then watch and interact with the selected video from 70 on his or her video device, such as personal computer 18, television 20 or digital television 24, while following along with the exercise class as if he or she is attending a class or program at a health club or exercise gym. Preferably, the selected video will be a live recording, previously recorded, of an actual exercise class that enables the user/viewer to follow along as if attending the class. Alternatively, the selected video can be a recording of an instructor who guides the user through the various steps of the exercise routine. In the preferred embodiment of the online gym 10, the user will have unlimited access to database 14 and usage of the plurality of exercise video programs contained therein and will be able to view and participate in any such programs within his or her user plan. As such, the user will be able to choose the day, time of day and the place that is most convenient for him or her, not for the instructor or health club/gym. This will greatly improve the user's ability to attend such classes and maintain his or her desired exercise program, even if the weather is bad or he or she is traveling away from home.

As set forth above, users can sign-up for one of a plurality of plans that are offered by the owner of the online gym 10, such as the three plans shown in FIG. 3. In Plan Level One, shown as 40, the user can choose from a group of exercise video programs that are directed to basic or general aerobics type of workouts, including but not limited to yoga, pilates, biking, circuit training, aerobics, kick boxing, step aerobics, treadmill, stretching & flexibility, Tae-bo, hip-hop aerobics, cardio, weight loss, dance & fitness, hula, strength and weights. The above, which are set forth merely as examples, can be offered in various intensity levels, such as a beginner, intermediate and professional. In Plan Level Two, shown as 42, the user can choose from a group of programs including the exercise video programs in Plan Level One plus a variety of “lifestyle” type of classes, such as stress relief, parenting, seniors, kids only, new mothers, teens, abs, thighs & butts and cheer. As with the above, these are only set forth as examples and they may be offered in a variety of different intensity levels, such as beginner, intermediate and professional. In Plan Level Three, shown as 44, the user can choose from a group of programs including the exercise video programs in Plan Level Two (which includes Plan Level One) plus a variety of “speciality” workouts, such as kung fu, karate, judo, soccer, basketball, football, baseball, tennis, ice hockey, climbing and hiking. As with the above, these are only set forth as examples and they may be offered in a variety of different intensity levels, such as beginner, intermediate and professional. Those skilled in the art will understand that the above is merely exemplary of a format for the online gym 10 of the present invention. The various exercise video programs could all be offered under a single plan or under any number of plans in a variety of different combinations, which may or may not include access to the video programs of lower level plans. In addition, registered users can be provided with the option to upgrade or downgrade their memberships. The various plans can include standard subjects for the exercise video programs and include certain types of subjects that may be more of a local nature.

The online gym 10 of the present invention is adaptable to a variety of different modifications that allow the owner of online gym 10 to provide exercise video programs under varying circumstances to people having a wide range of interests. For instance, as set forth above, the online gym 10 can be configured to work with transmission systems other than the Internet 12. Some of these other transmission systems may be more suitable for areas of the country or world that are more remote, such as certain military or aid stations that may be located in areas that do not have reliable Internet access. In addition, it may be advantageous to combine the online gym 10 of the present invention with cable or satellite television broadcast capabilities so the user can watch the selected video directly on a suitably configured television. In addition, the various exercise video programs and other components of online gym 10 can be offered in different languages and/or adapted with printed words for the deaf. In an alternative embodiment of the present invention, the online gym 10 can be utilized by local health clubs and exercise gyms to routinely video tape all of their exercise classes so that if a person is unable to make a particular exercise class he or she can choose that class and participate in the class when he or she is able to, thereby avoiding having to miss a class and falling behind others in the class. Numerous other modifications and variations can also be made to the basic online gym 10.

In use, the user access online gym 10 at the user interface 26 and, if he or she is a registered user, enters his or her user name and password at 28. If a new user, the user enters at 30 and enters the appropriate information to either become a registered user or to obtain a short term pass to review the site. Once the user enters database 14, comprising a plurality of exercise video programs and other information, he or she selects whether they want to enter their user plan, such as those shown on FIG. 3, utilize the pay-per-view feature at 68, enter the marketplace section 62 or access the health/fitness section 64. If the user desires to select an exercise video, he or she chooses a selected video from his or her user plan (such as the plans shown at 40, 42 and 44) or from the pay-per-view programs 68. Once a selected video is chosen, the user watches the video program on his or her video device and interacts therewith to accomplish the exercise routine. Because multiple classes of the same type and multiple levels of classes are offered, it is unlikely that the user will become bored or not be able to find a class that fits his or her needs and desires. The online gym 10 of the present can vastly improve the likelihood and ability of persons wanting to attend exercise classes by making such classes accessible to the person when and where it is convenient to him or her.

While the figures and description herein has set forth one or more preferred embodiments of the present invention, it will be readily apparent to those skilled in the art that the invention is not so limited, but is susceptible to various modifications and rearrangements without departing from the spirit and scope of the invention. For instance, many of the fundamental components used with the invention and described herein have equivalent functioning components that are well known with the art that can be used with the present invention. It is to be understood, therefore, that various modifications and rearrangements to the invention are contemplated herein. As such, the foregoing description is intended to be illustrative rather than limiting. The following claims, including all legal equivalents thereto, are intended to define the spirit and scope of the present invention.

What is claimed is:

1. A method of providing an exercise, dietary and health program to a user, said method comprising the step of providing a combination dietary and fitness/exercise plan to said user, said dietary and fitness/exercise plan comprising a dietary element, a fitness/exercise element and a written materials element.

2. The method according to claim 1 further comprising the step of assessing said user's health/fitness level and goals before said plan providing step.

3. The method according to claim 1 further comprising the step of providing access to an online gym over a transmission system after said plan providing step.

4. The method according to claim 3, wherein said transmission system is an Internet and said user interface is accessible and operable by a video device having a transmission system interface comprising an Internet browser.

5. The method according to claim 3, wherein said step of providing online gym access further comprises the steps of:
a) providing a user interface connected to and accessible through said transmission system;
b) providing a database operatively connected to said user interface, said database having a plurality of exercise video programs accessible to said user via said transmission system;
c) allowing said user to selectively choose a selected video from said plurality of exercise video programs; and
d) delivering said selected video to said user via said transmission system.

6. The method according to claim 5, wherein said user interface is configured to determine if said user is a registered user.

7. The method according to claim 6, wherein said database is only accessible through said transmission system to said registered user.

8. The method according to claim 5, wherein said database has a plurality of plan levels and said user selects one of said plurality of plan levels as a user plan, each of said plan levels comprising a group of said exercise video programs, said user interface configured to allow said user to access said user plan and choose said selected video from said group of said exercise video programs in said user plan.

9. The method according to claim 5, wherein said database further comprises a marketplace section, said marketplace section configured to allow said user to purchase one or more goods and services through said transmission system.

10. The method according to claim 5 further comprising the step of playing said selected video on a video device having a transmission system interface, said transmission system interface configured to receive and play said selected video so as to allow said user to interactively exercise while watching said selected video.

11. The method according to claim 1, wherein said dietary element comprises one or more calorie-controlled foods.

12. The method according to claim 1, wherein said fitness/exercise element includes one or more video fitness/exercise programs.

13. A method of providing an exercise, dietary and health program to a user, said method comprising the step of
a) assessing said user's health/fitness level and goals;
b) providing a dietary and fitness/exercise plan to said user, said dietary and fitness/exercise plan comprising a dietary element, a fitness/exercise element and a written materials element, said dietary element comprising one or more calorie-controlled foods and one or more video fitness/exercise programs; and
c) providing access to an online gym over a transmission system.

14. The method according to claim 13, wherein said step of providing online gym access further comprises the steps of:
d) providing a user interface connected to and accessible through said Internet;
e) providing a database operatively connected to said user interface, said database having a plurality of exercise video programs accessible to said user via said Internet;
f) allowing said user to selectively choose a selected video from said plurality of exercise video programs;
g) delivering said selected video to said user via said Internet; and
h) playing said selected video on a video device having a transmission system interface, said transmission system interface comprising an Internet browser and configured to allow said user to interactively exercise during said playing of said selected video.

15. The method according to claim 14, wherein said database has a plurality of plan levels and said user selects one of said plurality of plan levels as a user plan, each of said plan levels comprising a group of said exercise video programs, said user interface configured to allow said user to access said user plan and choose said selected video from said group of said exercise video programs in said user plan.

16. The method according to claim 15, wherein said database further comprises a marketplace section, said marketplace section configured to allow said user to purchase one or more goods and services through said Internet.

17. A system for providing exercise, dietary and health program to a user, said system comprising:
a dietary and fitness/exercise plan, said dietary and fitness/exercise plan comprising a dietary element, a fitness/exercise element and a written materials element, said dietary element comprising one or more calorie-controlled foods and one or more video fitness/exercise programs; and
an online gym accessible to said user over a transmission system.

18. The system according to claim 17, wherein said online gym further comprises a server computer having a user interface connected to and accessible through said transmission system, a database stored on said server computer and operatively connected to said user interface, said database having a plurality of exercise video programs accessible to said user via said transmission system, a video device connected to said user interface through said transmission system, said video device operated by said user so as to allow said user to selectively choose a selected video from said plurality of exercise video programs; and a transmission system interface interconnecting said video device and said transmission system, said transmission system interface configured to receive said selected video from said database via said transmission system and play said selected video on said video device to allow said user to interactively exercise while watching said selected video.

19. The system according to claim 18, wherein said database has a plurality of plan levels and said user selects one of said plurality of plan levels as a user plan, each of said plan levels comprising a group of said exercise video programs, said user interface configured to allow said user to access said user plan and choose said selected video from said group of said exercise video programs in said user plan.

20. The system according to claim 17, wherein said transmission system is an Internet and said transmission system interface comprises an Internet browser.
